(19) United States
(12) Patent Application Publication
(10) Pub. No.: US 2021/0102109 A1
(43) Pub. Date: Apr. 8, 2021

(54) OIL AND GAS WELL FLUIDS

(71) Applicant: Raymond B. RICE, JR., Spring, TX (US)

(72) Inventor: Raymond B. RICE, JR., Spring, TX (US)

(21) Appl. No.: 17/020,427

(22) Filed: Sep. 14, 2020

Related U.S. Application Data
(60) Provisional application No. 62/899,449, filed on Sep. 12, 2019.

(51) Int. Cl. C09K 8/36; C09K 8/03; C10M 125/22; C10M 169/04; C10M 101/02; C10M 143/14; C10M 113/12

(52) U.S. Cl. CPC C09K 8/36; C09K 8/032; C10M 125/22; C10M 113/12; C10M 101/02; C10M 143/14; C10M 169/04

(57) ABSTRACT

A drilling mud is provided, the drilling mud comprising green diesel comprising de-oxygenated oil, water; and one or more fine particle solids. The green diesel may be formed from an edible oil or non-edible feedstock. The drilling mud fine particle solids comprise bentonite, barite, ferrophosphate ore, calcite, or siderite. The drilling mud may comprise stabilizing additives such as emulsifiers, weighting agents, fluid loss additives, alkali reserves, and viscosity regulators. In other embodiments, lubricants for drilling fluids comprise green diesel and lubricity additives such as solvents, esters, and surfactants. The lubricant may further comprise graphite or polytetrafluoroethylene. A slurry for use in oil and gas drilling operations comprises green diesel, polysaccharides or polyacrylamides, and a thickener such as silica, bentonite clay, and waxes. A wireline lubricant comprises green diesel, one or more block polymers, and one or more corrosion inhibitors.

This application claims the benefit of Provisional Application No. 62/899,449 filed Sep. 12, 2019, the contents of which are incorporated by reference.

### FIELD OF THE INVENTION

The present invention relates to fluids used in drilling, completing and production of oil and gas wells.

### BACKGROUND OF THE INVENTION

The process of extracting hydrocarbons by wells from subterranean formations involves various and distinct processes such as drilling, completion, and production. Each of these processes is very unique and utilizes fluids injected or pumped into the wells. For example, during drilling of the well, drilling fluids and muds are pumped down to bring drill cuttings back to the surface and provide lubrication for the drill bit. During completion of the well, fraccing fluids may be pumped downhole to increase the porosities of the formations and improve oil and gas flow into the well. During production of oil and gas from the well, the well may need to be worked over from time to time, requiring fluids injected downhole to temporarily stop production.

Many of the fluids injected or pumped downhole are oil based, as opposed to water based. Oil-based well fluids include drilling muds, slurries of xanthan and guar, and friction reducers used in fraccing.

Some examples of the types of oils used for oil-based well fluids are as follows: diesel fuels, kerosene, light crude, and high refined mineral oils. The Environmental Protection Agency (EPA) regards fluids with benzene, toluene and xylene (the so-called BTX fluids with aromatic hydrocarbons) as hazardous. Diesel, kerosene and light crude contains BTX compounds. Use and disposal of well fluids with BTX compounds leads to incidents that manifest a report to the EPA. A manifested incident calls into play aggressive and expensive action to clean up or minimize environmental contamination. Well operators prefer to use well fluids than do not require an EPA manifest.

An alternative to petroleum diesel is biodiesel. Biodiesel is a methyl ester, which is oxygenated, and has water affinity. The use of biodiesel has been found to be less than satisfactory. Other examples include high refined mineral oils, which usually have a much lower aromatic content that is generally accepted as cleaner. Still other types of oils used are of high grade/high refined oils such as iso-parafin used in polyacrylamide emulsions or severely hydro-treated napthenics. Recently, there has been a drive towards synthetic drilling fluids such as those derived from the polymerization of ethylene. However, these products have been found economically restricted as they are expensive.

Due to environmental concerns, it is desirable to use cleaner oil and gas well fluids, with less environmental impact.

### DESCRIPTION OF THE PREFERRED EMBODIMENT

This invention is directed towards the application of renewable oils for the oil and gas exploration and production industry. The renewable oils include green diesel, which is a renewable because it is derived from renewable resources such as plant or animal matter. The green diesel is used in well fluids for drilling, completing, and extracting hydrocarbons from subterranean formations by way of wells. By using green diesel, other types of oil-based fluids, such as petroleum-derived diesel, need not be used in well fluids.

Such well fluids, with green diesel, allow the use of renewable resources, rather than unrenewable resources. Furthermore, such well fluids have greater levels of biodegradability and much lower levels of bioaccumulation. Overall, they offer a much lower environmental impact. In many cases, renewable oils have shown to provide higher levels of performance in formulations that normally utilize conventional oils.

Green diesel, also referred to as de-oxygenated oil, is made from edible oil feedstocks such as palm oil, soybean oil or rapeseed oil. Other plant-derived oils could be used as a feedstock. Alternatively, non-edible oil feedstocks such as algal and jatropha oils can be used. Also, tallow oil and waste greases can be used. Feedstocks rich in saturated fats, such as palm and tallow oils, require substantially less hydrogen than feedstocks with a higher olefin content, such as soybean and rapeseed oils. The feedstock may need to be processed to remove contaminant such as solids and salts.

Green diesel has a similar molecular structure as petroleum-derived diesel. Green diesel has been produced by a hydrotreating of triglycerides in vegetable oils with hydrogen. The hydrotreating process consists of three main reactions: hydrodeoxygenation (HDO), decarbonylation (DCO) and decarboxylation (DCO2), is operated to remove oxygen, carbon monoxide and water, and carbon dioxide respectively.

The feedstock is fed into two reactors, sequentially. The reaction process uses direct catalytic hydrodeoxygenation (hydrogenolysis) of plant oils, which are triglycerides, into the corresponding alkanes and propane. The glycerol chain of the triglyceride is hydrogenated to the corresponding C3 alkane, propane, without a glycerol sidestream. This process removes oxygen from the oil; the diesel is not an oxygenate, such as traditional transesterified biodiesel. Green diesel is chemically identical to ideal conventional, or petroleum-derived, diesel, it requires no modification or special precautions for the engine.

The feedstock is brought up to a predetermined pressure, and sent to first reactor, which is an adiabatic, catalytic hydrodeoxygenation reactor. Hydrogen is introduced into the reactor, either directly or mixed with the feedstock. The reactor operates at predetermined temperature and pressure ranges and saturates and deoxygenates the oil. The conversion of the feedstock can produce a volumetric yield of deoxygenated hydrocarbon products of greater than 100%. The stream from the first reactor undergoes processing to separate out water, carbon dioxide and low molecular weight hydrocarbons.

The stream enters a second reactor, which is a catalytic hydro-isomerisation reactor. This produces a branched paraffin-rich diesel fuel, which is green diesel. Various characteristics of the green diesel can be selected, such as boiling-range paraffin, cold flow properties, cloud points, etc.

The hydrogen can be supplied by recycling unused hydrogen from the second reactor into the first reactor. The second reactor uses little hydrogen. Any additional hydrogen can be supplied from another source. For example, steam reforming can be used on a light fuel co-product can be steam reformed to obtain hydrogen.

Relative to petroleum-derived diesel, green diesel has a comparable boiling range, a lower density and a higher cetane content.

Green diesel is different from biodiesel. Biodiesel is also made from edible and non-edible oils. But biodiesel is a methyl ester, which is oxygenated, and has water affinity. Green diesel and biodiesel, even though they are derived from similar feedstocks, are chemically different. This is due to the different refining process used to make green diesel, which process de-oxygenates the resulting product.

Some examples of green diesel in well fluids are given below.

### Oil-Based Drilling Fluids

One of the advantages of using green diesel in drilling mud is that the mud can be oil-based (OBM). Prior art oil-based mud usage is limited by environmental concerns. As a result, water-based drilling muds are used. However, water-based. muds (WBM) generally give rise to high coefficients of friction (COF) between the drill string and the wellbore and, therefore, have high torque and drag. In addition, water-based muds can also increase wear rates in the wellbore. For contact between steel and rock, oil-based muds (OBM) generally produce COFs that are lower than those produced by WBM.

Drilling fluids, or drilling mud, are used while a well is being drilled. The well has a drill stein and a drill bit on the bottom of the drill stein. Drilling mud is circulated inside the drill stein to the drill bit, where it exits and ascends the well bore in the annulus surrounding the drill stein.

Drilling mud is designed for the particular well conditions and therefore may contain various components. Oil-based drilling fluids are generally used as so-called invert emulsion muds which consist of a three-phase system, namely: oil, water and fine-particle solids. These are preparations of the w/o emulsion type, i.e. the aqueous phase is heterogeneously distributed as a fine dispersion in the continuous oil phase. The drilling mud includes green diesel as the oil component and water. Ratios of green diesel to water may vary from 60/40 to 90/10 by volume. The fine particle solids are bentonite and/or barite, which also contribute to viscosity and weight of the drilling mud. Other density control components that can be used include ferrophosphate ore, calcite, and/or siderite.

Various additives are present for stabilizing the system as a whole and for establishing the desired performance properties including, in particular, emulsifiers or emulsifier systems, weighting agents, fluid loss additives, alkali reserves, viscosity regulators and the like. Organophilic lignitic, asphaltic and polymeric materials may be added to help control HP/HT(High pressure/High temperature) fluid loss. Oil-wetting ensures that particulate materials remain in suspension. The surfactants used for oil-wetting also can work as thinners. The drilling mud may contain lime to maintain an elevated pH, resist adverse effects of hydrogen sulfide (H₂S) and carbon dioxide (CO₂) gases, and enhance emulsion stability. Shale inhibition may be desirable in the drilling mud. A high-salinity water phase helps to prevent shales from hydrating, swelling, and sloughing into the wellbore. The use of calcium chloride brine provides shale inhibition properties. Another component may be for fluid-loss control, and can include starch (corn and potato), polyanionic cellulose polymer, xanthum gum, sodium carboxymethyle-cellulose, and/or lignite. In a well experiencing lost circulation the following are used, namely ground nut shells, micas, ground cellophane, diatomaceous earth, cottonseed hulls, ground or shredded paper. Corrosion and scale control additives can be used and include sodium sulfite, zinc chromate, tall oil, amines, sodium hydroxide, phosphates, and bacteriocides.

Green diesel has a lower specific gravity than that of petroleum-derived diesel. While petroleum-derived diesel has a specific gravity of 0.84, green diesel has a specific gravity of 0.78 (when made from the above process with vegetable oil as a feedstock). Thus, substituting green diesel for petroleum-derived diesel on a one-to-one basis results in a less dense drilling mud. Accordingly, the drilling mud typically has a higher water content and/or a higher weighting agent content in order to achieve the desired density.

As an example, if the oil/water (o/w) ratio is 75/25 (75% green diesel, V1 and 25% water, V2), the following material balance is set up:

(V1×W1)+(V2×W2)

where W1 is the weight of green diesel oil ppg (pounds per gallon) and W2 is the weight of water ppg. The weight of green diesel oil, W1,=6.5 ppg and the weight of water, W2=8.33 ppg. Applying these:

(0.75×6.5)+(0.25×8.33)=6.96

Therefore, the density of the oil/water mixture=6.96 ppg

This density can be used to determine the starting volume of the base fluid (oil plus water), which is used to prepare a desired volume of mud.

As an example formula of a drilling mud, the following components are used, by weight:

| | | |
|---|---|---|
| Green diesel oil | 55 to 70% | Oil component |
| D-Limonene | 1 to 5% | Pour point depressant |
| Biocide | .1 to .5% | Antioxidant |
| Fatty acid salts | 3 to 6% | Puffer |
| Magnesium oxide | 1 to 3% | Soap former |
| NaCl Brine | 26 to 30% | Aqueous component |
| Organophilic clay | .5 to 1% | Viscosifier |
| PAC polymer | .1 to .5% | Fluid loss additive |
| Barite | 1 to 5% | Weighting agent |

The example formula can be modified to meet certain specifications, such as density, lubrication, etc.

The drilling mud with green diesel is used in accordance with conventional practice. The mud is pumped into the well for circulation, allowed to flow down the drill stein, and up the annulus. The drilling mud exiting the well is recovered and processed to remove cuttings and for reuse. The various components may be added to the recovered and processed drilling mud to bring the drilling mud into specification before being reinjected into the well.

Because the green diesel contains no aromatic hydrocarbons, if the drilling mud is soiled on the ground, an EPA incident is not manifested. Likewise, the same is true for disposal of the drilling mud. (Note that the drilling mud may contain additives with aromatic hydrocarbons which would require incidents to be manifested.)

### Lubricants for Drilling Fluids

Commonly known as rate of penetration enhancers (ROP) or drill lubes, these products are formulated to increase the lubricity of the drilling fluids. Generally speaking, they are best applied into water-based mud systems. Not only do they increase lubricity, they also prevent material from sticking and “balling” on the bit.

The lubricant is primarily green diesel. Additives can be provided, such as solvents, esters, surfactants and various other lubricity additives. Solids, such as graphite or PTFE (polytetraflouroethylene), can be added.

The lubricant is added to the drilling mud in an effective amount to achieve the desired coefficient of friction (COF).

As an example formula of a drilling fluid lubricant, the following components are used, by weight:

| | |
|---|---|
| 2-Ethylhexyl oleate | 10 to 20% |
| Green diesel oil | 30 to 50% |
| Soya sulfonate | 10 to 20% |
| Glycerol monotallate | 10 to 15% |

The example formula can be modified to meet certain specifications, such as lubrication, etc.

### Lubricants for Completion

Commonly known as “pipe on pipe”, these are a family of products designed to provide lubricity during re-entry or “cased hole” operations. These operations are performed using stick pipe or coiled tubing rigs. As the work string is conveyed into the well bore the contact between the work string and the casing causes significant friction. Lubricants are added to the circulated fluid (generally water or weighted brine) to alleviate the friction.

The lubricant is primarily green diesel. Additives can be provided, such as solvents, esters, surfactants and various other lubricity additives. Solids, such as graphite or PTFE (polytetraflouroethylene), can be added.

The lubricant is added to the circulated fluid in an effective amount to achieve the desired lubricity or coefficient of friction (COF).

As an example formula of a completion lubricant, the following components are used, by weight:

| | |
|---|---|
| Tall oil Fatty acid | 5 to 10% |
| Polyethylene glycol 400 dioleate | 5 to 10% |
| Green diesel oil | 30 to 80% |
| Fine ground graphite | 5 to 10% |

The example formula can be modified to meet certain specifications, such as lubrication, etc.

### Slurries for Oil and Gas

Suspensions or “slurries” of high molecular weight products are often used in oil and gas for various applications. A common application involves reducing friction. Green diesel is used to make the suspension or slurry.

Products such as xanthan or guar gum and various other polysaccharides are used. Also commonly used are high molecular weight polyacrylamides. These products are suspended into a hydrocarbon carrier oil using some form of thickening agent to help suspend the powders. The thickeners are commonly forms of silica, bentonite clay or waxes. The products are used to viscosify water or brine for drilling, hydraulic fracturing and composite plug drill outs as well as being used as friction reducers.

As an example formula of a slurry, the following components are used, by weight:

| | | |
|---|---|---|
| Green diesel oil | 30 to 80% | Oil component |
| Fumed silica | 10 to 20% | Thickener |
| Fine ground polymers | 10 to 25% | Active |

The example formula can be modified to meet certain specifications, such as viscosity, lubrication, etc.

### Friction Reducers

Used predominantly in hydraulic fracturing, or fraccing, operations, friction reducers are added to the high volumes of water being pumped in order to reduce the pressures at the well head and surface equipment. They also allow the operators to maintain the prescribed pumping rate into the reservoir, a critical key to the success of the fraccing operation. The friction reducers include green diesel.

The friction reducers are all forms of polyacrylamides in an emulsion or invert emulsion form. Various reactions of the acrylamide will give the end product characteristics to suit the operators very specific needs. These characterisics include Charge (anionic, cationic, nonionic) degree or strength of this charge and molecular weight. Many different monomers can be reacted with the acrylamide to provide unique properties. All of the formulations general take the form of an emulsion or invert emulsion. The reactions can be carried out using the emulsion polymerization process using the selected monomers, water, oil and specialty surfactants. The oils are generally high grade paraffinic “white” oils.

### Wireline Lubricants

Wireline lubricants, also referred to as “honey oil” or “wireline grease”, provides a seal between the atmosphere and well during wireline operations. The lubricant also provides a boundary film on the wireline cable itself. This protects the cable from the harmful effects of the formation fluids and gasses.

The lubricant includes green diesel, with block polymers that increase the viscosity to the desired point. The lubricant also includes corrosion inhibitors, H₂S (hydrogen sulfide) inhibitors, anti-oxidants and anti-wear additives for reducing friction and keeping wireline wear down to a minimum thus providing maximum protection to the line, even under the most severe operating conditions. Also extreme cold weather formulations can comprise of full synthetics using poly alpha olefin chemistry.

As an example formula of a wireline lubricant, the following components are used, by weight:

| | | |
|---|---|---|
| Green diesel oil | 30 to 90% | Oil component |
| Vinyl or poly iso butylene polymer | 5 to 20% | Viscosity improver |
| Over based calcium sulfonate | .1 to 1% | Corrosion inhibitor |

The example formula can be modified to meet certain specifications, such as viscosity, lubrication, etc.

The lubricant is applied to the wireline cable by way of a conventional and commercially available lubricator. The wireline passes through the lubricator. The lubricant is pumped through the lubricator, where it contacts and coats the wireline.

The foregoing disclosure and showings made in the drawings are merely illustrative of the principles of this invention and are not to be interpreted in a limiting sense.

1. A drilling mud adapted for use in oil and gas drilling operations, the drilling mud comprising:
green diesel comprising de-oxygenated oil;
water; and
one or more fine particle solids.

2. The drilling mud of claim 1, the green diesel being formed from an edible oil feedstock.

3. The drilling mud of claim 1, the green diesel being formed from a non-edible oil feedstock.

4. The drilling mud of claim 1, the fine particle solids chosen from the group consisting of bentonite, barite, ferrophosphate ore, calcite, and siderite.

5. The drilling mud of claim 4, further comprising stabilizing additives chosen from the group consisting of emulsifiers, weighting agents, fluid loss additives, alkali reserves, and viscosity regulators.

6. A lubricant for drilling fluids, the lubricant comprising:
green diesel comprising de-oxygenated oil; and
lubricity additives chosen from the group consisting of solvents, esters, and surfactants.

7. The lubricant of claim 6 further comprising graphite or polytetrafluoroethylene.

8. A slurry for use in oil and gas drilling operations, the slurry comprising:
green diesel comprising de-oxygenated oil;
polysaccharides or polyacrylamides; and
a thickener.

9. The slurry of claim 8, wherein the thickener is chosen from the group consisting of silica, bentonite clay, and waxes.

10. A wireline lubricant for lubrication of a wireline used in oil and gas drilling operations, the lubricant comprising:
green diesel comprising de-oxygenated oil;
one or more block polymers; and
one or more corrosion inhibitors.

11. The wireline lubricant of claim 10, wherein the one or more block polymers comprise vinyl or poly iso butylene polymers.

12. The wireline lubricant of claim 10, wherein one of the one or more corrosion inhibitors comprises over based calcium sulfonate.
